(19) United States
(12) Patent Application Publication
(10) Pub. No.: US 2009/0055295 A1
(43) Pub. Date: Feb. 26, 2009

(54) FINANCIAL BENEFITS PROGRAM

(76) Inventor: Yossef BARGIL, Haifa (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(21) Appl. No.: 12/195,442

(22) Filed: Aug. 21, 2008

Related U.S. Application Data
(60) Provisional application No. 60/956,934, filed on Aug. 21, 2007.

(51) Int. Cl. G06Q 20/00

(52) U.S. Cl. 705/30

(57) ABSTRACT

A method for providing financial benefits to Company associates buying at vendors chosen by the Company. The first benefit is a money payment to associates by the Company based on the collective spending of all associates at chosen vendors. The second benefit is a money payment by the Company to associate for each referral materializing into an additional association with the Company. The third benefit is an additional money payment to associates by the Company based on a combination of collective associate spending at all chosen vendors and payment recipient down line spending.

### FIELD AND BACKGROUND OF THE INVENTION

The present invention relates to a business method and, in particular, a financial benefits program using collective and individual spending at chosen vendors as a basis for providing benefits to program participants.

Vendors commonly provide customers with financial benefits in order to attract them and win their patronage. These benefits vary from simple cash rebates and credit points, to savings deposits and investment program enrollments that reward buyers in direct proportion to their spending. Such programs typically suffer from an insufficient capital base that can provide substantial financial benefits without diminishing company profits. Companies have addressed this shortcoming by creating incentive schemes offering interest accruing and savings plans thereby providing the spender with opportunities for a long-term gain surpassing their individual spending. However, these programs loose their appeal as incentives because the substantial earnings eventually gained are barely perceptible on a short-term basis. Multi-level-marketing schemes provide short-term gains by directing a portion of recruit spending to customers referring additional customers to the company of interest. These programs suffer from a number of shortcomings:
The heavy reliance on recruitment of additional buying members limits company growth because many customers lack the temperament needed to recruit others, the recruitment incentives are therefore appealing only to those customers willing to undertake the task of continually recruiting additional buyers.
Frequently program participants are locked into buying a particular product or product line.
New members must pay up-front cash membership fees.

There is therefore a need for a financial benefit program that offers substantial short-term benefits based on group and personal spending, applicable to a wide diversity of products, and accessible without paying up-front cash program entry fees.

### SUMMARY OF THE INVENTION

The present invention is a financial benefit program providing reimbursements and referral fees to program associates, the reimbursements are based on a combination of collective associate and personal spending at chosen vendors.

According to the teachings of the present invention there is provided a method for providing financial benefits to associates of a company comprising: (a) buying at a plurality of chosen vendors that reimburse said company in accordance with collective actual spending received from said company associates, (b) monitoring said collective actual spending of said company associates at said plurality of chosen vendors by said company, (c) paying money to at least one of said company associates by said company in an amount defined in accordance with said collective actual spending of: (i) said associates whose association with said company was facilitated by said associate receiving payment, and (ii) said associates whose association with said company was not facilitated by said associate receiving payment.

According to a further feature of the present invention, wherein the amount defined in accordance with said collective actual spending increases as said collective actual spending achieves pre-defined thresholds.

According to a further feature of the present invention, wherein there is also provided paying money as a referral fee by said company to an associate for facilitating an establishment of an additional association with said company.

According to a further feature of the present invention, wherein there is also provided paying additional money to said associate who is an originator of a family of said associates referred to said company, the amount of said additional money being a fraction of total actual spending of said associate family at said plurality of chosen vendors, said fraction being defined in accordance with the reimbursed portion of said collective actual spending of all of said company associates at all of said plurality of chosen vendors.

According to a further feature of the present invention, wherein the fraction being defined in accordance with the reimbursed portion of said collective actual spending increases as the reimbursed portion of said collective actual spending achieves predefined thresholds.

According to a further feature of the present invention, wherein the fraction is implemented as a number of permils.

### BRIEF DESCRIPTION OF THE DRAWINGS

The invention is herein described, by way of example only, with reference to the accompanying drawings, wherein:

FIG. 1 outlines the three available financial benefits available in the current program;

FIG. 2 is a block diagram depicting the interrelationships between the Company, the Chosen Vendors, and the Associate Group;

FIG. 3 depicts the overall transfer of funds between the relevant participants, the Associate Group, the Vendors, and the Company;

FIG. 4 depicts the reimbursement stage for a First Financial Benefit;

FIG. 5 depicts the flow of monies for a the First Financial Benefit;

FIG. 6 depicts a payment stage of a Second Financial Benefit;

FIG. 7 depicts several Referred Associate Families and their corresponding Family Heads for a third Financial Benefit;

FIG. 8 depicts the reimbursement and payment stages of the Third Financial Benefit; and

FIG. 9 is a summary of the all Financial Benefits generated for a particular spending model.

### DESCRIPTION OF THE PREFERRED EMBODIMENTS

The present invention is a program serving as a basis for providing Company Associates a number of financial benefits for buying at Chosen Vendors or facilitating the establishment of additional associations with the Company. The interrelationships between the participating parties of the present invention may be better understood with reference to the drawings and the accompanying description.

Following are terms of usage to be used through out the document:
“Company” refers to a company employing the current financial benefit program.
“Vendors” refers to businesses or a product owners that have independently agreed to make financial reimbursements to the Company based on spending received from customers supplied by the Company.
“Associate” refers to a person or organization that has established a contractual relationship with the Company.
“Reimbursement” refers to a transfer of an entity of value to the Company as a fulfillment of the Vendors' commitments to the Company.
“Money” refers to a universally accepted entity of value.
“Collective spending” refers to the sum of constituent spending of the Associates.
“Family” refers to a collection of referred Associates who share a common first referring Associate.
“Family Head” refers to the first referring Associate in a chain of referred Associates up to a predefined number of generations.
“Multi-level-marketing” refers to a payment scheme in which a person receives a portion of spending received by a vendor from customers referred by him or from other customers in a chain of referrals emanating from the customer.

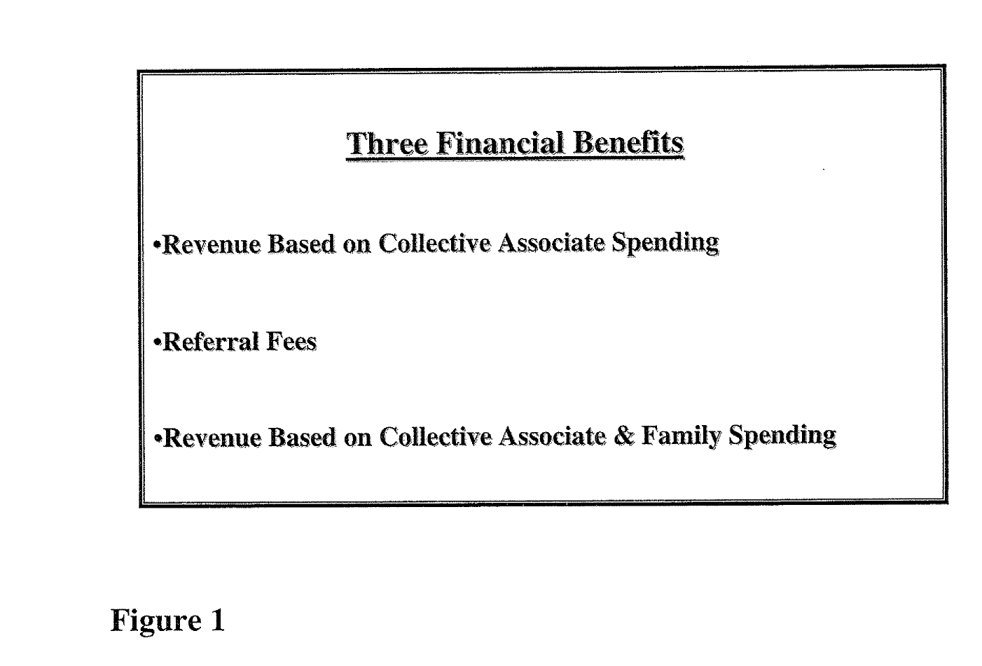

Referring now to the drawings, FIG. 1 presents three distinct revenues provided by the Company. As mentioned above, the financial benefits include reimbursements derived from spending derived from collective Associate and personal spending at Chosen Vendors, and referrals fees. Preferably, the revenues are paid on a monthly basis, but the plan may be implemented on a weekly, bi-weekly, annual, or any time basis agreed upon by the Company, the Customers, and Chosen Vendors. Furthermore, it should be noted that the current invention advantageously employs money payments of any currency.

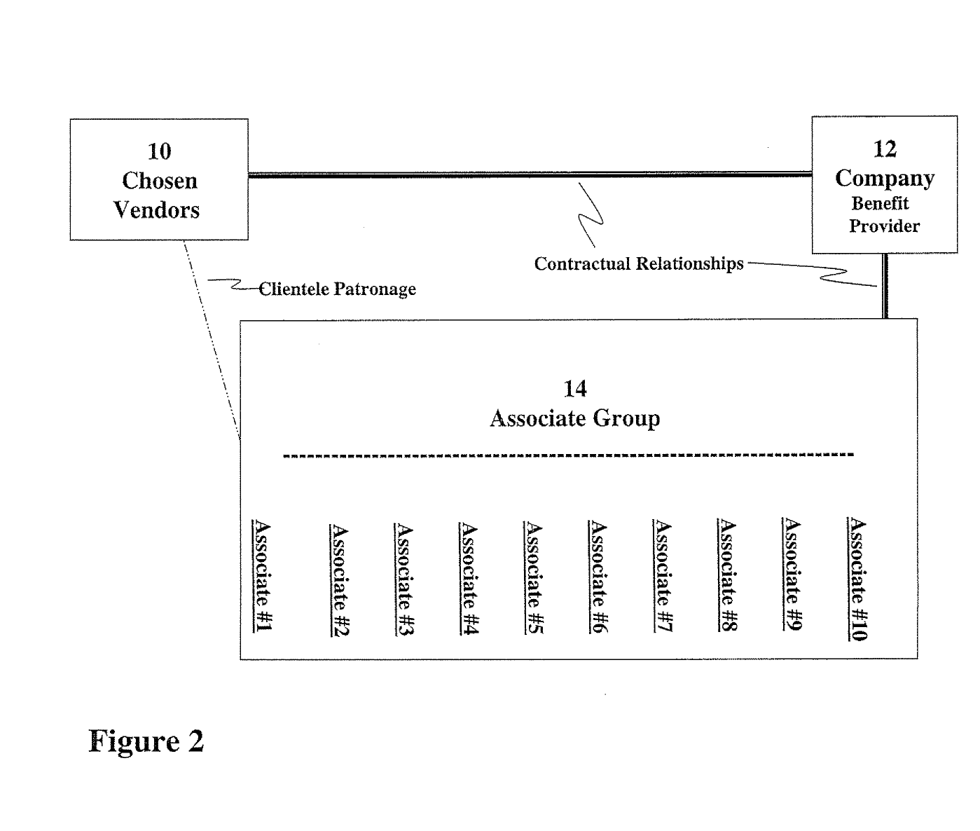

FIG. 2 illustrates the contractual relationships existing between the Company 12 the Chosen Vendors 10, and the Associates 14. The Company 12 establishes a contractual relationship committing to provide the above-mentioned financial benefits in exchange for buying at Chosen Vendors 10 or for referrals materializing into an association with the Company. A one-time entrance fee to the Company 10 is deducted from future reimbursements to be generated by future spending thereby negating up-front fees. The Company 12 provides the customer with an identification number and/or a membership card or any other means of identifying and tracking his spending and recruiting activities.

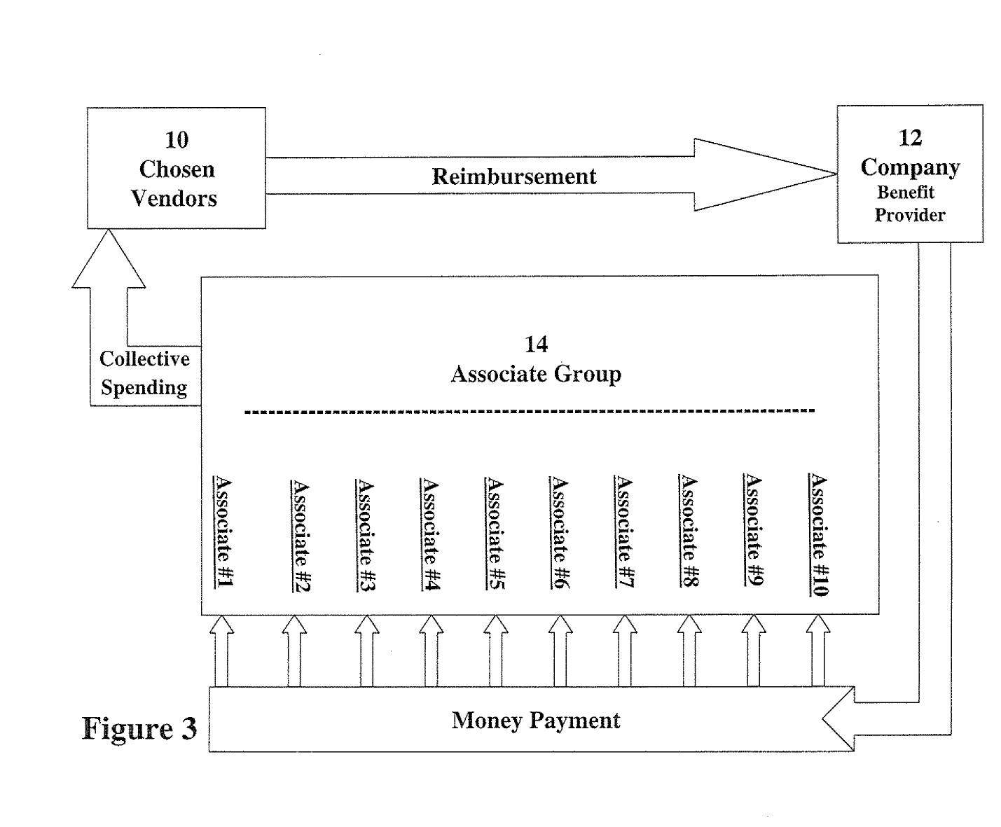

The Company 12 establishes a contractual relationship with each Chosen Vendor 10 in which the Company 12 commits to supply customers buying at normal prices in exchange for reimbursements to the Company 12 based on their collective spending as illustrated in FIG. 3. These customers have established an association with the Company either based on the Company's recruiting efforts or on the efforts of existing Associates as will be discussed later. It should be noted that the Company establishes such contractual relationships with a large number of Vendors in order to provide a large range of user goods and services. It should be appreciated that Company's ability to establish additional relationships and to negate existing relationships advantageously provides a dynamic product diversity for the Associates.

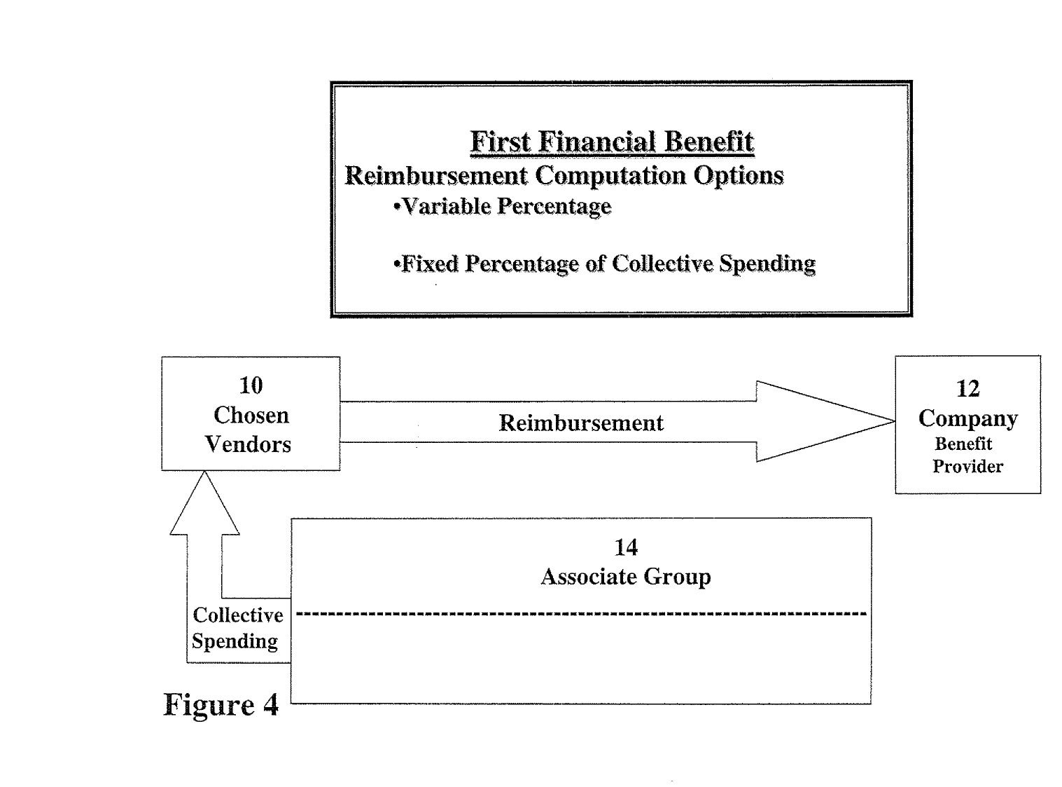

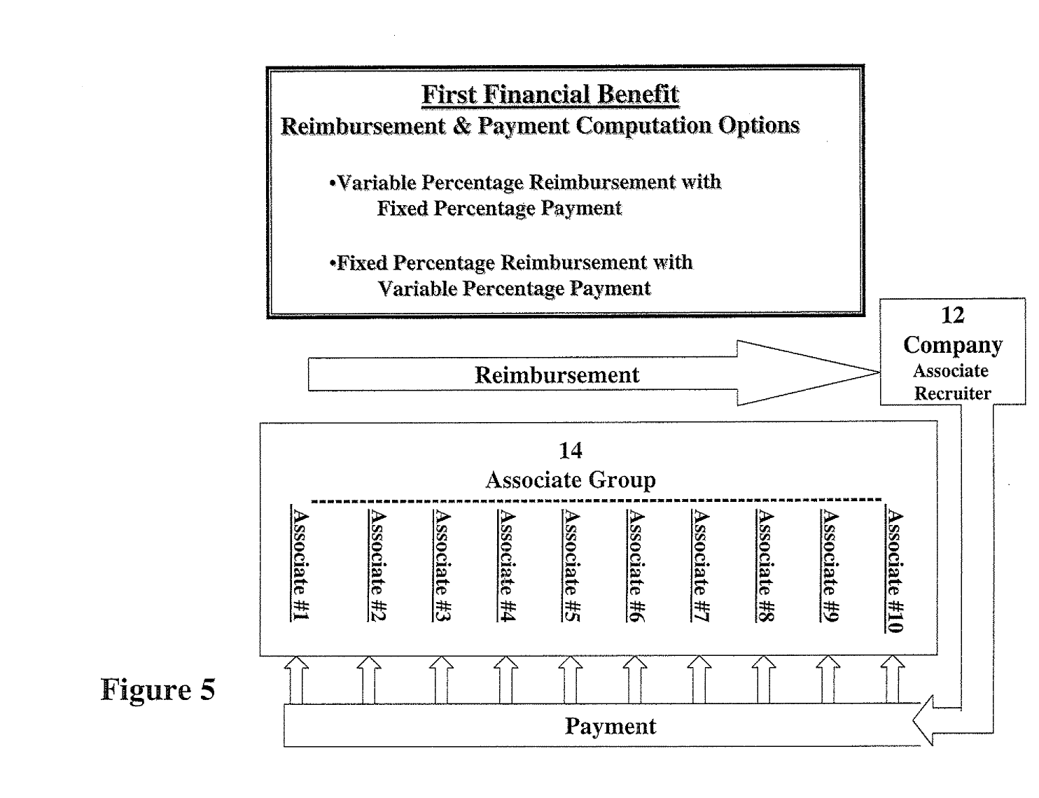

FIGS. 3-5 illustrate the transfer of funds for the first benefit. By way of example, each one of ten customers included in the Associate Group 14 buys $100 worth of goods from each of five Chosen Vendors 10 that have committed to reimburse an increasing fraction of the collective spending received from the Associate Group 14 as the spending achieves predefined thresholds as follows:

| | % Reimbursement < Spending |
|---|---|
| Vendor | Threshold < % Reimbursement₂ |
| #1 | 10% < $2000 ≦ 12% |
| #2 | 8% < $3500 ≦ 15% |
| #3 | 12% < $3000 ≦ 18% |
| #4 | 5% < $3400 ≦ 10% |
| #5 | 3% < $4000 ≦ 6% |

Additionally, the Company 12 has committed to pay each Associate 80 percent of that fraction of the reimbursement emanating from his individual spending Therefore each Vendor 10 receives a collective income from the Associate Group 14 of $1000 and reimburses the Company 12 as follows:

| | | Reimbursement to |
|---|---|---|
| Vendor | Income | Company |
| #1 | $1000 | $100 |
| #2 | $1000 | $80 |
| #3 | $1000 | $120 |
| #4 | $1000 | $50 |
| #5 | $1000 | $30 |

The Company 12, as mentioned above, in turn pays each Associate 80% of that fraction of the reimbursement emanating from his personal spending at each Vendor as follows:

| | Individual Contribution to | Payment to Customer |
|---|---|---|
| | Company Reimbursement | (80% of Individual |
| Vendor | (10% of Reimbursement) | Contribution) |
| #1 | $10 | $8.00 |
| #2 | $8 | $6.40 |
| #3 | $12 | $9.60 |
| #4 | $5 | $4.00 |
| #5 | $3 | $2.40 |

| | |
|---|---|
| Total | $30.40 |

The current plan includes provisions to increase the number of members included in the Associate Group 14 through Company 12 recruiting and through the Associate recruiting as mentioned above. The Associate recruitment aspect of the plan employs a multi-level-marketing scheme to generate additional revenues for the Associate recruiter as will be discussed later. The additional Associates increase the size of the current Associate Group 14 and correspondingly increase the collective Group 14 spending thereby impacting significantly the revenues received by non-recruiting Associates. By way of example, an Associate that has recruited 24 additional customers increases the size of the Group from 10 to 34 customers. The $100 spending example described above produces the following revenues:

| | | | Individual | Payment to |
|---|---|---|---|---|
| | | Reimbursement | Contribution to | a Single |
| | | to Company | Company | Associate |
| | Income | According to | Reimbursement | (80% of |
| | $100 × 34 | Agreed Rates | ( 1/34 of | Individual |
| Vendor | Associates | (See Above) | Reimbursement) | Contribution) |
| #1 | $3400 | $408 | $12 | $9.60 |
| #2 | $3400 | $272 | $8 | $6.40 |
| #3 | $3400 | $612 | $18 | $14.40 |
| #4 | $3400 | $340 | $10 | $8.00 |
| #5 | $3400 | $110.16 | $3.24 | $2.60 |

| | |
|---|---|
| Total | $50.00 |

As shown above the first revenue benefit receives a return of 30. 4 dollars when belonging to a group of ten Associates whereas an Associate belonging to a group of 34 members receives a return of 50 dollars with no additional individual spending or recruiting. The accruing nature of this benefit advantageously provides the potential for substantial short-term benefits.

It should be further noted that only two spending thresholds and their corresponding reimbursement rates are illustrated herewith for the sake of brevity but any number of income thresholds and their corresponding reimbursement rates are within the scope of the current invention.

An alternative, or additional embodiment, employs a reimbursement based on a fixed percentage of Associate Group 14 spending and Company 12 payments based on a variable percentage of the reimbursement emanating from individual spending. Continuing with the above example of ten Associates spending $100 at each of five Vendors 10, but rather reimbursing a fixed percentage of collective Associate spending while the Company 12 pays the Associates a variable percentage of the individual contribution to the Vendor reimbursements according to the following thresholds and corresponding percentages:

| | % Reimbursement of | Payment % < Reimbursement |
|---|---|---|
| Vendor | Collective Spending Received | Threshold < % Payment |
| #1 | 10% | 60% < $200 ≦ 70% |
| #2 | 5% | 75% < $100 ≦ 80% |
| #3 | 7% | 85% < $60 ≦ 90% |
| #4 | 6% | 65% < $120 ≦ 75% |
| #5 | 12% | 80% < $110 ≦ 85% |

Applying the thresholds and their corresponding percentages to the above example of ten Associates spending $100 spending at each of five Vendors, the payment schedule is as follows:

| | | Vendor | Percentage Applied to |
|---|---|---|---|
| | Collective | Reimbursement to | Individual Contribution to |
| Vendor | Spending | Company | Reimbursement |
| #1 | $1,000 | $100 | 60% |
| #2 | $1,000 | $50 | 75% |
| #3 | $1,000 | $70 | 90% |
| #4 | $1,000 | $60 | 65% |
| #5 | $1,000 | $120 | 85% |

| | Payment to a Single |
|---|---|
| | Customer |
| Personal | (% Applied to Indiv. |
| Contribution to | Contribution to |
| Reimbursement | Reimbursement) |
| $10 | $6.00 |
| $5 | $3.75 |
| $7 | $6.3 |
| $6 | $3.9 |
| $12 | $10.2 |
| Total | 30.15 |

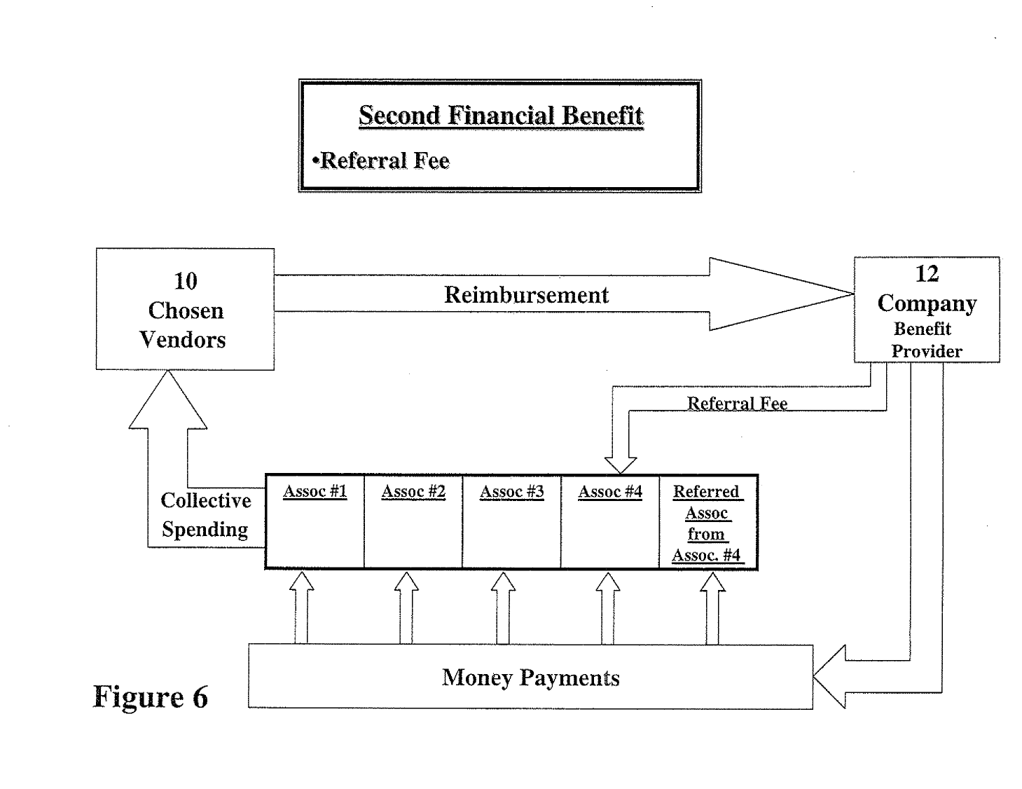

FIG. 6 depicts a second financial benefit paid to Associates as a one-time payment for referring to the Company 12 an individual or an entity that establishes an association with the Company. After the Company establishes that a particular Associate facilitated a new association, the referring Associate receives a one-time payment from the Company 12. The Company 12 pays the referral fee when the new Associate accumulates payments exceeding the amount of the fee.

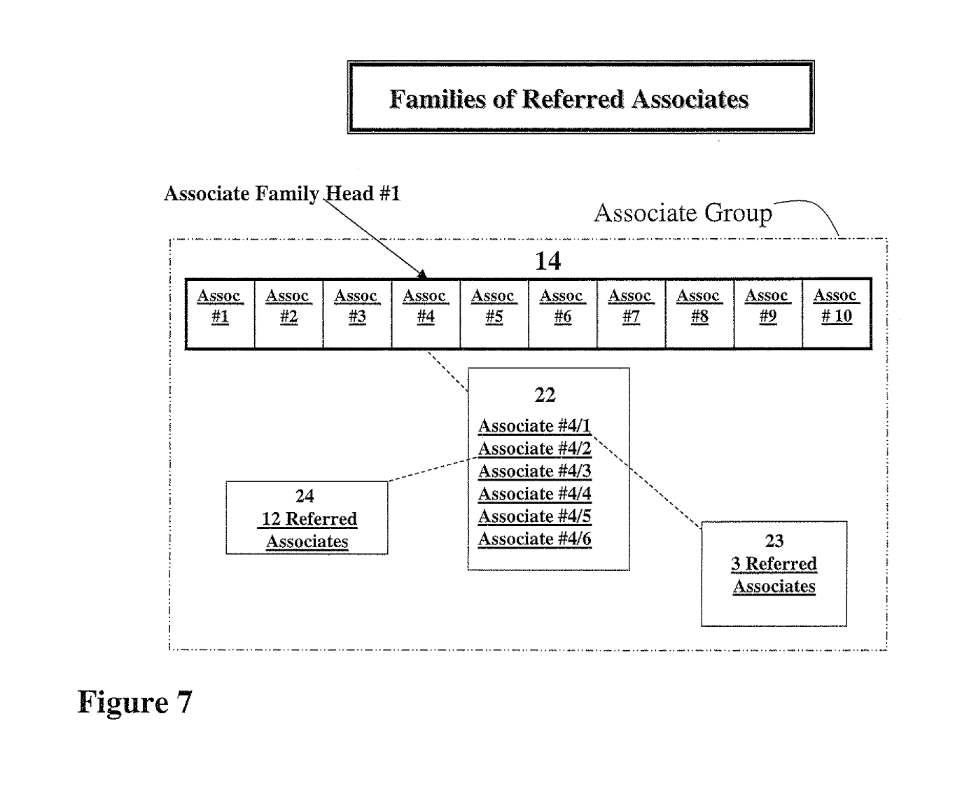

FIG. 7 illustrates the entire Association Group 14 with its component elements. The Group 14 includes ten Associates, 1-10, in which each has established a relationship with the Company directly, without referrals. The other element of the Group 14 includes those Associates that have established an Association with the Company by way of referrals. As may be seen in FIG. 7 Associate #4 has facilitated six Associates. The first referred Associate 4/1 has, in turn, referred three additional individuals that established an association to the Company as shown in designation 23. Associate #4/2 has likewise initiated 12 additional Associates as shown in designation 24. Therefore, Associate #4 is a Family Head of a twenty four member referred Associate Family including sub-families designated 22, 23, and 24 whereas Associate #4/1 is a Family Head for a three member Associates Family 23 and Associate #4/2 is a Family Head for Referred Associate Family 24 of 12 members.

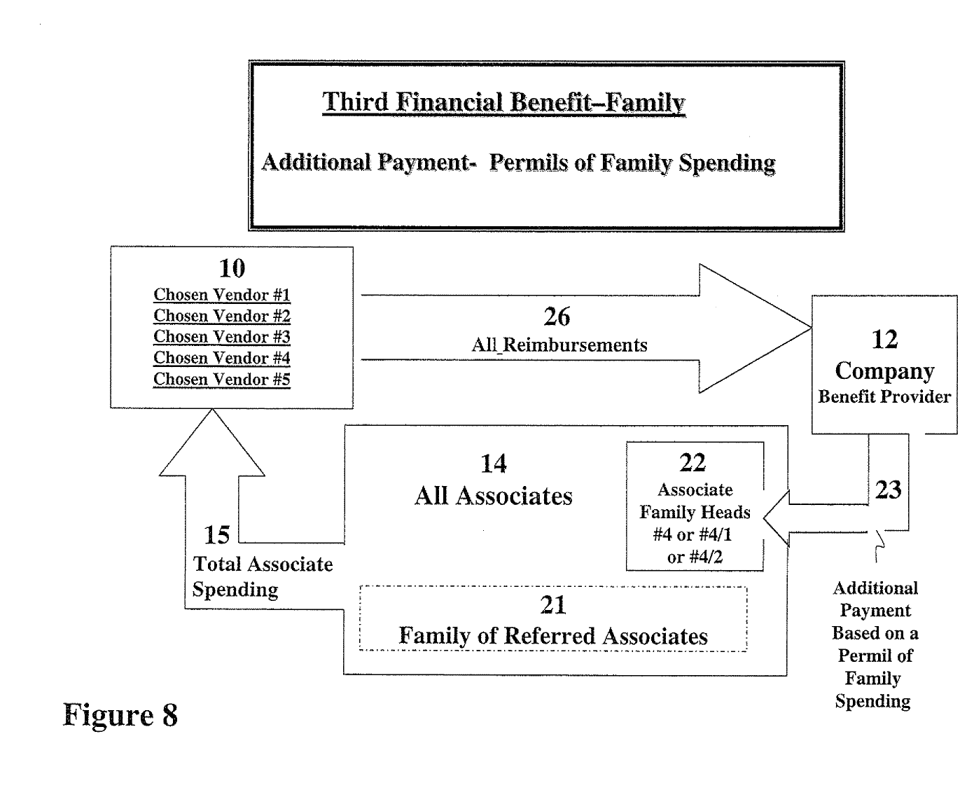

FIG. 8 depicts a third revenue incentive based on a combination of total Associate Group 14 and Family 21 spending. In a preferred but non-limiting embodiment, any one of Associate Family Heads #4, #4/1 and #4/2 depicted collectively in FIG. 8 as designation 22 receives a fraction of Associate Family 21 spending originating from his referrals. The fraction is calculated on a permil basis in accordance with the percentage of total Associate Group 14 spending at all Chosen Vendors 10 reimbursed to the Company 12. The permil increases as the percentage of the total spending reimbursed to the Company 12 reaches predefined thresholds. Calculating the third benefit for Family Head #4 by way of the above example of five Chosen Vendors 10 that have agreed to reimburse the Company 12 according to the following parameters mentioned above:

| | % Reimbursement < Spending |
|---|---|
| Vendor | Threshold < % Reimbursement₂ |
| #1 | 10% < $2000 ≦ 12% |
| #2 | 8% < $3500 ≦ 15% |
| #3 | 12% < $3000 ≦ 18% |
| #4 | 5% < $3400 ≦ 10% |
| #5 | 3% < $4000 ≦ 6% |

As mentioned above each of ten Associates included in the Associate Group 14, spends $100 at each Chosen Vendor 10 in a first month and spends $105 in a second month. Associate #4 referral activities develop into a 24 member Family 21 that together with the existing members totals to thirty-four Associates as shown in FIG. 8. This model produces the following reimbursements:

| | | | 2nd | |
|---|---|---|---|---|
| | 1^{st} Month | | Month | |
| | Total | | Total | |
| | Spending | Reimbursement | Spending | Reimbursement |
| Vendor | Received | 1^{st} Month | Received | 2^{nd} Month |
| #1 | $3,400 | $340 | $3,570 | $428.40 |
| #2 | $3,400 | $272 | $3,570 | $535.50 |
| #3 | $3,400 | $612 | $3,570 | $642.60 |
| #4 | $3,400 | $340 | $3,570 | $357.00 |
| #5 | $3,400 | $102 | $3,570 | $107.10 |

The Company 12 has committed to pay a half permil of all Family 21 spending for reimbursement to the Company 12 less than 11 percent of total Associate Group 14 spending and one permil for reimbursements achieving 11 percent. Therefore the third revenue incentive paid by the Company 12 to Family Head 22 for a first month of spending is as follows:

Total Group spending at all Vendors

| | |
|---|---|
| $3400 × 5 Chosen Vendors = | $17,000 |

Total Family spending of Customer #4

| | |
|---|---|
| $100/Customer × 24 Customers × 5 Chosen Vendors = | $12,000 |

Total Reimbursements

| | |
|---|---|
| $340 + 272 + 612 + 340 + 102+ = | $1666 |

Percentage of Total Associate Group Spending

| | |
|---|---|
| Reimbursed to Company = $1666/$17,000 × 100% = | 9.8% |

Permil to be Paid to Family Head

| | |
|---|---|
| 9.8% < 11% → | 0.5 0/00 |

Revenue Incentive Paid to Assoc. Family Head

| | |
|---|---|
| $1,2000 × .0005 = | $6 |

In the second month the Financial Benefit paid to the Family Head #4 is calculated similarly:

Total Group Spending at All Vendors

| | |
|---|---|
| $3570 × 5 Chosen Vendors = | $17850.0 |

Total Family Spending of Customer #4

| | |
|---|---|
| $105/Customer × 24 Customers × 5 Chosen Vendors = | $12600.0 |

Total Reimbursements

| | |
|---|---|
| $428.4 + 535.5 + 642.6 + 357 + 107.1 = | $2070.1 |

Percentage of Total Associate Group Spending Reimbursed to Company

| | |
|---|---|
| $2070.1/$17850 × 100% = | 11.6% |

Permil to be paid to Family Head

| | |
|---|---|
| 11.6% > 11%-> | 1.0 0/00 |

Financial Benefit Paid to Family Head

| | |
|---|---|
| $12600 × .001 = | $12.6 |

As mentioned above every Associate is a Family Head in regards to referrals within a chain of referrals originating from him. Considering the above example in regards to Associate #4/1 now designation 22 who is a Family Head for three referred Associates now designation 21 in the $100/Associate spending model, the computation of the third benefit for Associate Family Head #4/1 is as follows:

Total Associate Spending at all Vendors

| | |
|---|---|
| $3400 × 5 Chosen Vendors = | $17,000 |

Total Family spending of Associate Family Head #4/1 =

| | |
|---|---|
| $100/Customer × 3 Customers × 5 Chosen Vendors = | $1,500 |

Total Reimbursements

| | |
|---|---|
| $340 + 272 + 612 + 340 + 102+ = | $1666 |

Percentage of Total Associate Group Spending

| | |
|---|---|
| Reimbursed to Company = $1666/$17,000 × 100% = | 9.8% |

Permil to be paid to Associate Family Head

| | |
|---|---|
| 9.8% < 11% → | 0.5 0/00 |

Revenue Incentive paid to Assoc. Family Head

| | |
|---|---|
| $1,500 × .0005 = | $2.25 |

It should be noted that a fractional basis other than a permil is also within the scope of the current invention. In a preferable but non-limiting embodiment the Associate Family extends six generations, however Families extending additional generations are also within the scope of the current invention.

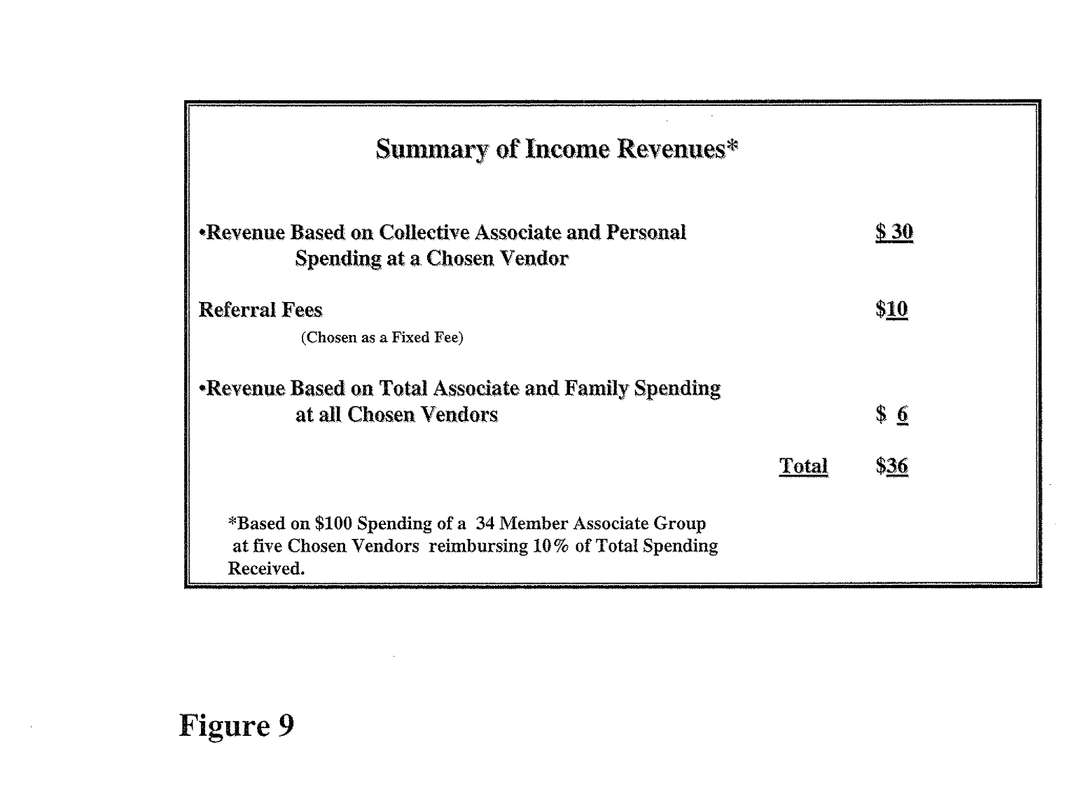

FIG. 9 summarizes the revenue incentives available based on the above example of an Associate Group 14 whose 34 members each spend $100 at each of the five Chosen Vendors Chosen Vendors 17.

It will be appreciated that the above descriptions are intended only to serve as examples, and that many other embodiments are possible within the scope of the present invention as defined in the appended claims.

What is claimed is:

1. A method for providing financial benefits to associates of a company comprising:
(a) buying at a plurality of chosen vendors that reimburse said company in accordance with collective actual spending by said company associates,
(b) monitoring said collective actual spending of said company associates at said plurality of chosen vendors by said company,
(c) paying money to at least one of said company associates by said company in an amount defined in accordance with said collective actual spending of:
(i) said associates whose association with said company was facilitated by said associate receiving payment, and
(ii) said associates whose association with said company was not facilitated by said associate receiving payment.

2. The method of claim 1, wherein said amount defined in accordance with said collective actual spending increases as said collective actual spending achieves pre-defined thresholds.

3. The method of claim 1 further comprising paying money as a referral fee by said company to an associate for facilitating an establishment of an additional association with said company.

4. The method of claim 1 further comprising paying additional money to said associate who is an originator of a family of said associates referred to said company, the amount of said additional money being a fraction of total actual spending by said associate family at said plurality of chosen vendors, said fraction being defined in accordance with the reimbursed portion of said collective actual spending of all of said company associates at all of said plurality of chosen vendors.

5. The business method of claim 4 wherein said fraction being defined in accordance with the reimbursed portion of said collective actual spending increases as said reimbursed portion of said collective actual spending achieves predefined thresholds.

6. The method of claim 5 wherein said fraction is implemented as a number of permils.
